(19) United States
(12) Patent Application Publication
(10) Pub. No.: US 2023/0162119 A1
(43) Pub. Date: May 25, 2023

(54) SYSTEM AND METHOD FOR DECISION MAKING

(71) Applicant: PRENARIO PTY LTD, Prahran, Victoria (AU)

(72) Inventor: Leonard HICKEY, Prahran (AU)

(73) Assignee: PRENARIO PTY LTD, Prahran, Victoria (AU)

(21) Appl. No.: 17/802,850

(22) PCT Filed: Mar. 1, 2021
(86) PCT No.: PCT/AU2021/000019

§ 371 Date: Aug. 26, 2022

(30) Foreign Application Priority Data
Feb. 28, 2020 (AU) 2020900581

(51) Int. Cl. G06Q 10/0637

(52) U.S. Cl. CPC G06Q 10/06375

(57) ABSTRACT

There is disclosed a computer implemented method of representing a problem to be solved by making one or more decisions, comprising: generating a plan comprising a plurality of cards for each event associated with the problem, each card comprising at least a choice card that represents a choice to be made for a future event to occur, a chance card that represents a future event occurring from said choice; arranging said cards in sequential order such that the size of each card in the sequential order is determined such that all cards that emanate from an immediately preceding card fall within a footprint of the immediately preceding card; assigning a probability to each choice card representative of a probability of each future event occurring; defining goals for measuring a success of one or more of the future events occurring, each goal being either a quantitative measure or a qualitative measure of the outcome of the future event occurring; and generating an end result for each future event at the completion of each sequence of cards, said end result being representative of the probability of each future event occurring the goals defined for that future event.

### RELATED APPLICATIONS

The present application claims priority from Australian provisional patent application No. 2020900581 filed on 28 Feb. 2020, the entire contents of which are incorporated herein by reference.

### FIELD OF INVENTION

The present invention relates generally to a system and method for making decisions, and in particular, to a system and method for displaying and presenting various aspects of a decision in order to make the most informed decision.

### BACKGROUND OF THE INVENTION

On any day, situations arise which require individuals and teams to make a decision in order to move forward. The types of situations may differ in complexity and importance, and the types of outcomes may also vary. For some situations, the outcome may be insignificant in importance, thereby the decision may not require much analysis by the individual or team considering it. However, for other situations, the potential outcomes may be extremely significant, thereby requiring much time and analysis in performing the decision to ensure that the most optimum outcome ensues.

As a result, a variety of tools have been proposed to assist individuals/organisations in making the best decision to achieve the most desirable outcome. One of the most common tools used for such purposes is a system for graphically representing problems in the form of a “Decision Tree”. A Decision Tree is typically drawn from left-to-right in chronological order of encountering the decisions, the uncertainties present in each decision, and the set of possible outcomes associated with each decision.

A typical decision tree requires a decision to be represented as a node generally having a square/rectangle form. Stemming from each decision node is a branch that represents an outcome for each decision node. Chance or uncertainty nodes may be employed for each outcome, typically represented as a circle, and a number of branches may spread from each chance or uncertainty node, depending upon the possible outcomes that may result. End nodes, typically depicted as a triangle, represent the consequences of the decision after it has followed the various diverging paths. As a typical Decision Tree is structured from left-to-right to represent the chronological order in which the decisions, chances and possible consequences occur, a problem with Decision Trees is that they can grow very large and become difficult to use and interpret as they may expand across many sheets/screens. A Decision Tree only has burst nodes that diverge into paths and has no converging paths, hence the overall size of a Decision Tree can quickly become unwieldly to use, especially when the Decision Tree is to be displayed on a piece of paper or on a computer screen.

Furthermore, existing Decision Trees have been developed to ensure that the size of each node and the spacing between nodes is uniform; however, as more o consequences are added the spacing between the consequences at the end of the Decision Tree becomes non-uniform. This makes it difficult to add more chance/uncertainty nodes without creating a congestion problem and causing the nodes to overlap and the entire Decision Tree to become unusable. This makes it difficult to use Decision Trees to model decisions beyond a few decision nodes, as they become too congested for non-trained individuals to use and understand.

Thus, there is a need to provide an alternative system or tool for decision making which improves the ability to visualise the problem in a simple and effective way.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a computer implemented method of representing a problem to be solved by making one or more decisions, comprising:
generating a plan comprising a plurality of cards for each event associated with the problem, each card comprising at least a choice card that represents a choice to be made for a future event to occur, a chance card that represents a future event occurring from said choice;
arranging said cards in sequential order such that the size of each card in the sequential order is determined such that all cards that emanate from an immediately preceding card fall within a footprint of the immediately preceding card;
assigning a probability to each choice card representative of a probability of each future event occurring;
defining goals for measuring a success of one or more of the future events occurring, each goal being either a quantitative measure or a qualitative measure of the outcome of the future event occurring; and
generating an end result for each future event at the completion of each sequence of cards, said end result being representative of the probability of each future event occurring the goals defined for that future event.

In one embodiment, the end result generated for each future event may be presented on a result card located at an end of the sequence of cards.

Each card may be represented as a substantially rectangular block.

In one embodiment, the cards may be arranged in a left to right sequential manner with the cards diminishing in size from left to right.

In another embodiment, the cards may be arranged in a top to bottom sequential manner with the cards diminishing in size from top to bottom.

The probability assigned to each choice card may be displayed on the choice card.

### BRIEF DESCRIPTION OF THE DRAWINGS

The invention may be better understood from the following non-limiting description of preferred embodiments, in which:

FIG. 1 is a screen shot depicting a plan configured using the software tool in accordance with an embodiment of the present invention;

FIG. 2 is a screen shot depicting a plan configured using the software tool in accordance with another embodiment of the present invention;

FIG. 3 is a screen shot depicting a plan configured using the software tool in accordance with yet another embodiment of the present invention; and

FIG. 4 is a screen shot depicting the plan of FIG. 3 in a more detailed form using the software tool in accordance with the present invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to a new method of approaching decision making. The method is implemented by a new presentation structure that is different to a conventional Decision Tree and is preferably implemented through the use of computer software controlling the operating system of a computer, which may be locally or centrally hosted, or cloud based.

The computer typically includes a central processing unit (CPU) and/or at least one graphics processing unit (GPU) or the like with includes one or more microprocessors and memory operably connected to the CPU and/or GPU and/or the like. The memory can include any combination of random-access memory (RAM), a storage medium such as a magnetic hard disk drives(s) and the like. The storage medium may be used for long term storage of program components as well as storage of data relating to the users of the system and their transactions. The central processing unit and/or graphics processing unit which is associated with random access memory 10, is used for containing program instructions and transient data related to the operation of services associated with the computer. In particular, the memory 10 contains a body of instructions 14 for implementing at least part of a method for performing decision analysis in accordance with the present invention. The instructions 14 can provide a system which can be deployed to multiplatform, including desktop computer, NVIDIA DRIVE or Jetson embedded platform. The instructions 14 may also include instructions for providing a web-based user interface which enables users to remote access the system from any client computer executing conventional web browser software.

The system of the present invention offers a departure from the convention nodes and branches structure of a Decision Tree and replaces this structure with a card based structure. Cards enable the integration of textual information into the structure of the system and significantly improve the user experience. Through the associated software, users are able to hide details on the cards or allow details to be revealed when the user selects a specific card. Such a system enables presentation of information of direct interest to the user and does not provide information overload, which is a problem with conventional Decision Tree systems.

The present invention utilises the following terminology to define the features of the system:
1. Event—something that will or may happen in the future as a direct or indirect consequence of a decision to be made now;
2. Cards—building blocks of the overall system. Cards contain events and there are two types of cards that can be used:
   a. Choice Card—a card that represents a situation where a choice needs to be made for one event to occur from a set of two or more mutually—exclusive potential events; and
   b. Chance Card—a card that represents where chance will determine one event to occur from a set of two or more mutually-exclusive potential events. Each event in a chance card must have a probability of occurring which is greater than 0% and less than 100%, and the sum of all probabilities on a chance card must equal 100%.

In order to use the system of the present invention, the user will create cards that each have a rectangular shape with the events appearing as a vertically stacked rows within the body of the card for horizontally arranged plans, or horizontally stacked columns for vertically arranged plans.
3. Plan—an arrangement of cards where each card is arranged according to certain rules to form sequences of events that represent possible future outcomes for a decision.

A completed Plan embodies information that can be used to calculate optimal decisions according to accepted practices in decision making science, such as, expected utility theory. In this way, a Plan represents the same underlying information present within a conventional Decision Tree, but presents this information in a new and improved visual form that overcomes the problems previously identified with conventional Decision Trees.
4. Goal—a benefit that can be determined in either a qualitative or quantitative form.
a. A qualitative goal may include a preference towards moving to a qualitative state, such as, improved customer happiness, better employee satisfaction.
b. A quantitative goal may include a preference for having more or less of a quantitative end result, such as, more money, less grams of sugar.

The main difference between the type of goals is that quantitative goals are more measurable by conventional means that qualitative goals. However, a qualitative goal may still be measurable in a Plan using goal scores, as will be discussed in more detail below.
5. Result—a result represents the immediate effect that an event has in relation to a goal. A result can have the following effect:
   a. Increase/decrease or neither increase/decrease a quantity for a quantitative goal; or
   b. Move closer towards/further away from or neither closer towards/further away a qualitative state for a qualitative goal.
6. End result—this represents the sum of all results from a unique sequence of events in a Plan. A Plan will have multiple end results which collectively represent the possible final outcomes for the decision to be made.

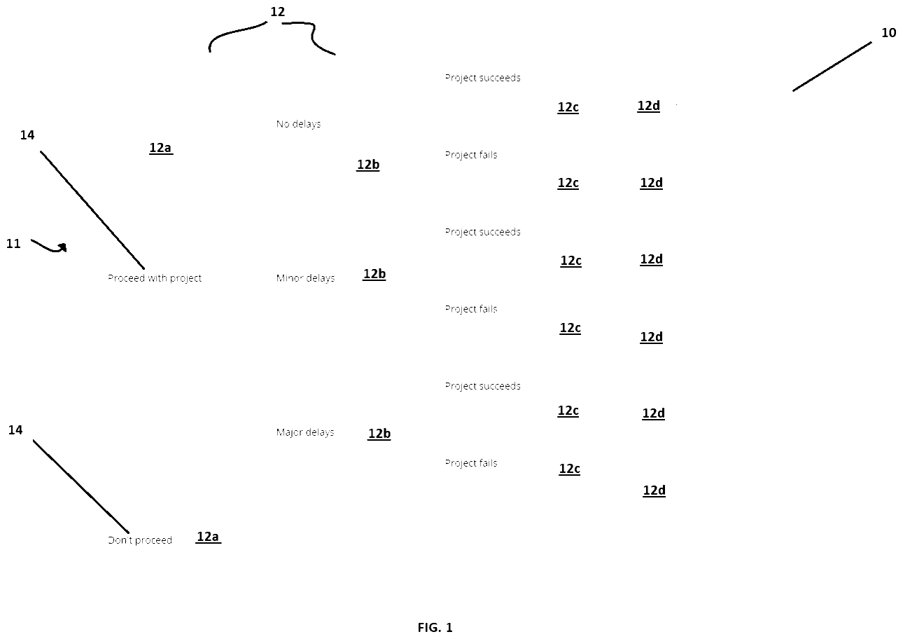

Referring to FIG. 1, a screenshot 10 of a Plan 11 is depicted. The Plan 11 is a project management plan and comprises a series of Cards 12 arranged according to the rules of the Plan 11. The Cards 12 are arranged in a branching sequence from right to left. The leftmost Cards of the Plan 10 contain Events 14 and are referred to as Choice Cards 12a, as they represent different situations where the user is required to make a choice. In this instance the Events 14 are to either “Proceed with the Project” or “Don't proceed”.

The second column of cards are each Chance Cards 12b and represent situations where, should the user choose to proceed with the project, the project will have either “no delays”, “minor delays” or major delays. Each Chance Card 12b depicts the probability for that situation to occur. As is depicted in FIG. 1, each of the three Chance Cards 12b in the second column are sized to correspond with the immediately preceding Choice Card 12a that leads to the Chance cards 12b. In this regard, each of the Chance Cards 12b that are associated with the preceding Choice Card 12a fall within the “footprint” of the preceding Choice Card 12a. In the present example where the plan 11 extends in a horizontal manner, the “footprint” is a vertical footprint defined by the height of the preceding Choice Card 12a.

However, should the plan 11 be arranged to extend in a vertical manner, the “footprint” may be a horizontal footprint defined by the width of the preceding Choice Card 12a. Similarly, following the Choice Card 12a for the choice “Don't proceed” there is a single Card 12 that has the same height or “vertical footprint” as the “Don't Proceed” Choice Card 12a, which depicts the Result of not proceeding with the project, which in this example, there is no result if the individual does not proceed.

The third column of Cards 12 also show Chance Cards 12c for each of the preceding Chance Cards 12b. The related Chance Cards 12c also have a combined height or “vertical footprint” that, matches the height or vertical footprint of the preceding Chance Card 12b from which they originate. The Chance Cards 12c also depict the probability of the Project succeeding and failing for each of the Events depicted in the preceding Chance Card 12b, for that event. As shown the probability of the project succeeding is dependent on the delays experienced, with fewer delays indicating a greater chance of project success.

The fourth and final column of cards 12 are Result Cards 12d that show the immediate effect that the event has in relation to the predetermined goals. In this example, the goals are qualitative and represent a perceived company happiness that the event will generate. In this regard, if the project proceeds with no delays and is a success, then this will return a +10 increase in company happiness, which is indicative of the most ideal situation. If, following the project having no delays, the project still fails, this will return a −2 decrease in company happiness. In comparison, if the project experiences major delays and succeeds, the company happiness will increase by +2 which is less than what is the case when the project succeeds with no delays, but positive nonetheless. This can be put down to the frustration than can ensue when a project experiences major delays, even if it does succeeds. The values set to define the result may be predetermined with consultation with the owner of the plan 11.

The Result Cards 12d for the plan 11 of FIG. 1 provide a clear indication of all the results possible from the unique sequence of events selected by the user in applying the system of the present invention. The user can clearly see that to ensure the maximum in company happiness, they must seek to minimise delays.

As can be seen from FIG. 1, all Plans 11 commence with a single foundation Choice Card 12a that represents the initial decision to be made. In essence this card is a Choice card 12a that displays the events, or more aptly, the options available to the user. As previously discussed, in use and dependent upon the preferences of the user, the Plan 11 may have a horizontal or vertical structure relative to the direction of text appearing in the Plan 11. In this regard, for English text that extends from left to right, the Plan can extend either horizontally left to right or vertically, top to bottom.

For horizontally extending plans, the height (H) of the Choice Card 12a is initially determined by the software as being at least equal to the sum of the individual heights of the event rows depicted thereon. The height (H) are also initially set by the software to an arbitrary height suitable for ensuring readability, typically large enough to enable relevant event details to be written on the card for clear viewing.

In developing the Plan, a single new card can be added to any of the options containing Choice Cards. Any new cards must be aligned such that their top and bottom edges are within the footprint, defined by the top and bottom edges of the option row that they are being added to. For example, in the Plan 11 depicted in FIG. 1, the Choice card “Major delays” is added to the option row and in doing so, the height of each of the other two Choice cards (No Delay and Minor Delay) are adjusted so that they each fall within the vertical footprint, namely the top and bottom edges of the preceding card, in this example “proceed with Project” card.

The height of the event rows in a new card will be initially set by the system software to a nominal value. When a new card is added to an option/event row, the height of that option/event row will automatically be increased by the software to ensure that the top and bottom edges of the row are not less than the top and bottom edges of the new card.

New cards may continually be added in this way until the Plan is complete.

It will be appreciated that the system software will be configured to allow new event rows to be added to previously added Cards, in which case new event rows initially have the height H. In this situation, the software will be configured to automatically increase the heights of the preceding cards to satisfy the above conditions.

The manner in which the Cards are controlled, as described above, provides an important aspect of the present invention. The various rules for creating the Cards ensure that the Cards are correctly configured and maximised in size to provide an intuitive and easy to understand hierarchy of events. This enables the user to simply understand the system and build a system to solve a myriad of different problem situations.

The system of the present invention also enables a user to add results to the events within a Plan. For qualitative goals, a user can use the present system to add a “goal score” for that goal. A goal score can either be a zero, or any positive or negative integer, and is typically selected to reflect an impact that the specific event has on a goal relative to the other events in the Plan.

In this regard, a given qualitative goal may have a qualitative state of “customer satisfaction”. A result may be added to an event in a Plan setting a goal score of “+1”. This means that the event will have the effect of moving closer to “customer satisfaction”. A result may also be added to a different event setting a goal score of “−3”. This means that this event will move away from “customer satisfaction” by an amount that is three times the event referred to above which has a goal score of (+1). It will be appreciated that more events may be added and existing results varied until the goal scores for the events in the Plan reflect the beliefs about the relative impact of each event in relation to its ability to deliver “customer satisfaction”.

It will be appreciated that the software of the present invention may also allow for the goal score for an event to be set based on an average of goal scores submitted by multiple people, so that the relative impact of the event will reflect an average of multiple user/stakeholder views.

With reference to FIG. 1, goal scores are used in this example to reflect a happiness rating such that a decision can be made which considers the company happiness that can be achieved. Clearly in this Plan, a project failure will result in an overall negative impact on company happiness, as would be appreciated. The events which provide the greatest company happiness will be where a project has no delays and succeeds, whilst a project that fails and had major delays provides the worst result.

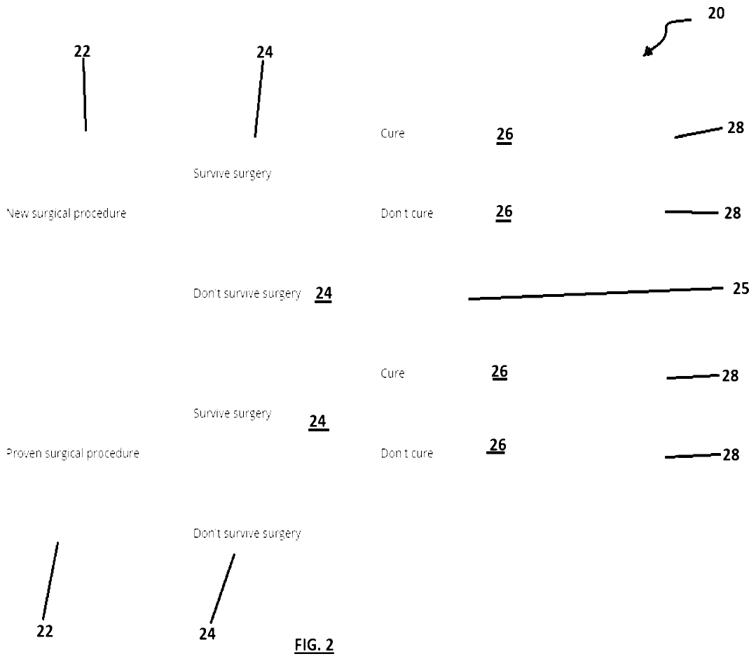

FIG. 2 depicts the decision making system of the present invention being employed for a very different Plan 20 than FIG. 1, namely to decide between a new surgical procedure or a proven medical procedure in order to treat a condition. This plan may be employed by a medical professional and/or patient to assess the options available to them to treat a condition.

The first column in FIG. 2 depicts a pair of Choice Cards 22 which depict a choice between two different events, namely to select a new surgical procedure or to select a proven surgical procedure. Each of the Choice Cards 22 have the same height, due to the following events each having the same number of options, as will be discussed in more detail below.

In the second column of Plan 20, Chance cards 24 are shown which essentially give a probability of surviving or not surviving for the new surgical procedure and the proven surgical procedure. As will be readily appreciated, irrespective of which decision is made from the Choice Cards 22, there are only two possible outcomes, survive or not survive. For ease of use, the percentages or odds for each event to occur are shown on each card to provide a clearer understanding of the likelihood of each event happening. As discussed previously, the percentages used may be determined from expert analysis or probability based on statistics.

In the third column of Plan 20, additional Chance Cards 26 are shown which depict the likelihood of the condition being cured following surgery. As this event can only occur if the user survives the surgery the Chance Cards 26 are only provided for each such event. As a result, the Chance Cards 24 depicted in Column two of the Plan 20 for the event “Survive Surgery” have a height greater than the Chance Cards for the event “Don't Survive Surgery”, as if the “Don't Survive Surgery” event occurs, the decision ends as depicted by the End Cards 25. As previously discussed, the sizing of the cards is automatically performed by the Software application to maximise the clarity and understanding of the procedure for the User.

The Chance cards 26 each provide a percentage or probability of occurring, which is set by the originator or creator of the plan 11. Each of the Chance cards 26 lead to an End card 28 that depicts a quantitative goal for the event, namely a number of additional years to the user's life.

As can be seen, from the Plan 20, whilst a decision to select a New Surgical procedure may have a lower chance of surviving the surgery, if the surgery cures the condition the user will add 5 years more to their lifespan should they select the proven surgical procedure and that being a success. It will be appreciated that the Plan 20 provides a simple and effective system for capturing and presenting the various issues associated with making such a decision.

It will be appreciated that with a software package of the present system, various features may by turned on/turned off in order to formulate a Plan.

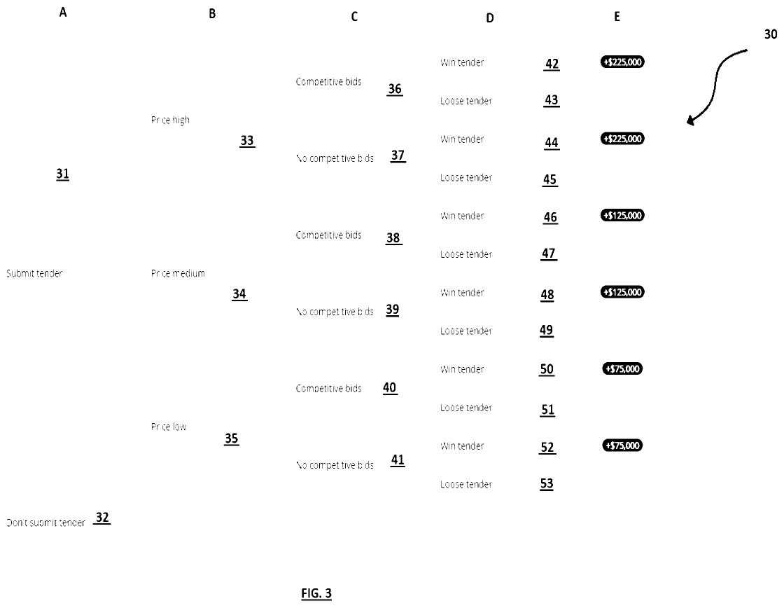

Referring to FIG. 3, a Plan 30 is depicted for deciding whether to submit a tender for a particular job, a decision faced by many contractors and the like.

In column A, Choice Cards 31, 32 are shown depicting the events that can occur to start the plan, namely, either “Submit Tender” or “Don't submit tender. As is shown, the height of the combined choice cards is selected such that all remaining cards in columns B, C, D and E for the Plan 30 fall within the height range or “footprint” of the Choice Cards 31 and 32 from which they emanate

In Column B, three Choice Cards 33, 34, 35 are provided within the footprint of the initial Choice Card 31 to represent the choices that follow should the user decide to submit a tender in Choice Card 31. The three Choice cards 33, 34, 35 provide the user with a choice to either submit a high price, submit a medium price or submit a low price for the tender. It will be appreciated that additional Choice Cards can be created for other options as determined by the creator of the plan 30.

In column C, for each Choice Card 33, 34, 35, there are two Chance Cards 36/37, 38/39 and 40/41. The pair of Chance Cards 36/37, 38/39 and 40/41 are the same for each Choice and represent an event whereby there are other competitive bids placed or no other competitive bids have been placed placed. As will be appreciated, the placement of competitive bids by competitors will have an adverse effect on the chance of winning the tender.

In column D, Result Cards 42/43, 44/45, 46/47, 48/49, 50/51 and 52/53 are provided for each of the Chance cards in Column C. The Result Cards represent the two results that can occur for the previous events, namely wither “win tender” or “lose tender”.

In column E, the End result is displayed for each Result Card 42-53. In this Event, the end result is a quantitative goal that is representative of the end financial result to the company in each combination of circumstances. The End Result displayed s a financial figure that takes into consideration the cost associated for submitting the tender ($25,000) and the successful tender price. In this regard, the cost for losing the tender will be $25,000 whilst the benefit for winning the tender will be the bid price minus the cost for submission.

From the display of FIG. 3, it is clear that the decision process behind the tender submission can be easily reviewed together with the potential windfall or loss associated with each event. In this regard, the user can readily understand the best decision course to take in order to maximise the end result.

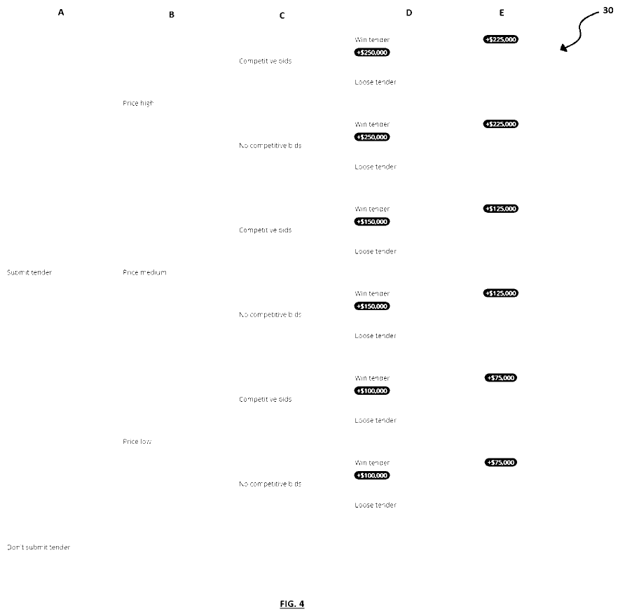

It will be appreciated that the software for performing the analysis as depicted in FIG. 3 can be adapted to turn on/off features as required. FIG. 4, depicts the same plan 30 as shown in FIG. 3 with the columns A, B, C, D and E representing the same Cards but with additional information.

The Chance Cards 36-41 in column C as depicted in FIG. 4 include percentages representing the probability of competitive bids being made by others or not. This can be set by the creator of the plan 30 based on experience or knowledge about the bidding process. Additional percentage probabilities are shown on the Chance Cards 42-53 together with winning tender amounts that are used to represent the End Card results. The probabilities shown on the Chance Cards 42-53 are representative of the fact that the higher the bid price the lower the probability of winning the tender and the fact that the more competitive bids received for the tender, the lower the likelihood of winning the tender.

It will be appreciated that whilst the Plans of FIGS. 3 and 4 are identical, the plan of FIG. 3 is simpler to follow as the Cards have less detail and are less distracting to the user. As such, for first-time users or users not familiar with the system, it may be more beneficial to turn off the amount of detail presented on the Cards so as to enhance the user experience. Such an option offered by the Software package of the present invention ensures that the system can be used by a wide variety of user's both experienced and inexperienced.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

The claims defining the invention are as follows:

1. A computer implemented method of representing a problem to be solved by making one or more decisions, comprising:
generating a plan comprising a plurality of cards for each event associated with the problem, each card comprising at least a choice card that represents a choice to be made for a future event to occur, a chance card that represents a future event occurring from said choice;
arranging said cards in sequential order such that the size of each card in the sequential order is determined such that all cards that emanate from an immediately preceding card fall within a footprint of the immediately preceding card;
assigning a probability to each choice card representative of a probability of each future event occurring;
defining goals for measuring a success of one or more of the future events occurring, each goal being either a quantitative measure or a qualitative measure of the outcome of the future event occurring; and
generating an end result for each future event at the completion of each sequence of cards, said end result being representative of the probability of each future event occurring the goals defined for that future event.

2. A method according to claim 1, wherein the end result generated for each future event is presented on a result card located at an end of the sequence of cards.

3. A method according to claim 1, wherein each card is represented as a substantially rectangular block.

4. A method according to claim 3, wherein the cards are arranged in a left to right sequential manner with the cards diminishing in size from left to right.

5. A method according to claim 3, wherein the cards are arranged in a top to bottom sequential manner with the cards diminishing in size from top to bottom.

6. A method according to claim 1, wherein the probability assigned to each choice card is displayed on the choice card.
